(19) United States
(12) Patent Application Publication
(10) Pub. No.: US 2004/0052918 A1
(43) Pub. Date: Mar. 18, 2004

(54) High energy complete food or nutritional supplement, method for preparing same and uses thereof

(76) Inventors: Andre Briend, Paris Cedex (FR); Michel Lescanne, Malaunay (FR)

Correspondence Address: Michael L Kenaga, Rudnick & Wolfe, P O Box 64807, Chicago, IL, 60664-0807, US

(21) Appl. No.: 10/415,112

(22) PCT Filed: Oct. 23, 2001
(86) PCT No.: PCT/FR01/03288

(30) Foreign Application Priority Data
Oct. 26, 2000 (FR) 00/13731

(51) Int. Cl. A23C 17/00

(52) U.S. Cl. 426/583

(57) ABSTRACT

A complete food or nutritional supplement consumable without addition of water and rich in lipids has not more than 2%-10% water by weight and has an osmolality of less than 100 mOsm/kg after immersion in a volume of water four times greater than its own weight. The supplement has a mixture of food grade products in powdered, granular or particulate form and has at least one powdered dairy product. It may also optionally have at least one product providing digestible carbohydrates and a vitamin and mineral salt supplement. The mixture is coated with at least one substance rich in vegetable fat including an emulsifier. It may also optionally have an antioxidant. The mixture does not include the protein, indigestible carbohydrate, and mineral of oleaginous seeds.

The invention relates to high-energy foods, with low osmolality, designed to be consumed as such, without addition of water, containing not more than 10% of their weight in water, which provide all the nutrients, and in particular proteins of dairy origin, lipids, carbohydrates, all the mineral elements and all the vitamins necessary for human nutrition. The foods in accordance with the invention are considered as complete foods because they make it possible, on their own, to cover the entire nutritional requirements of a subject.

The invention also relates to nutritional supplements providing all the nutrients present in insufficient quantity in diets where a single food, most often a cereal-based food, constitutes the majority of the food ration.

The subject of the invention is also the method for preparing these foods, and their uses.

Powdered foods prepared from powdered dairy products mixed with carbohydrates, vegetable fat and vitamins and minerals are often used to feed children. These powdered products have to be dissolved in water before being consumed. When they are designed for young children, these powdered products should have nutritional characteristics which satisfy the international standard described in Codex Alimentarius, CODEX STAN 156-1987 (amended in 1989).

Specific formulas which are also provided in powdered form to be diluted in water before consumption are used to re-feed subjects suffering from severe under-nourishment. These foods are also prepared from powdered milk products (skimmed milk, whey) mixed with carbohydrates, vitamins, minerals and lipids. The products which are currently most commonly used for this use are designated under the term of formulas F75 and F100. Their nutritional composition is described in “Management of severe malnutrition—A manual for physicians and senior health workers.” (Geneva, World Health Organization, 1999, p 13-14).

Their name serves as a reminder that after dilution, they provide 75 and 100 kcal/100 ml respectively.

Whether they are designed for feeding healthy children or undernourished children, powdered products nevertheless exhibit a number of disadvantages.

In the first place, powdered products, after dilution in water, represent an excellent culture medium for pathogenic bacteria which makes their use risky when hygiene conditions are bad, in particular in poor countries.

This dilution in water requires moreover the use of soluble mineral salts for enriching this type of food, with the risk of insoluble salts sedimenting at the bottom of the container. These soluble salts have a pronounced taste, and frequently have oxidizing properties higher than the insoluble salts. It is moreover difficult, in liquid foods, to coat, with chemically inert substances, the soluble mineral salts which have a pronounced taste and/or marked pro-oxidizing properties in order to mask the taste and/or to attenuate the chemical reactivity thereof. Indeed, the most common coating techniques render difficult the stable suspension of these minerals which have a tendency, after coating, to become deposited or, on the contrary, to rise to the surface when attempts are made to suspend them in a liquid.

Moreover, the presentation of these conventional foods in powdered form increases their surface in contact with the ambient atmosphere which penetrates inside the powder. This phenomenon exposes these foods to the, risk of oxidation during their preservation, and all the more so since they are provided in the form of a fine powder.

The presence of minerals having an oxidizing activity and the large surface of contact between the powdered product and the ambient atmosphere promote oxidation of the lipids, producing rancidity of the food, and also that of the vitamins which are sensitive to oxidation which they may contain, in particular vitamins C, A and E.

Moreover, it is difficult with conventional powdered foods for renutrition to reach an energy density much greater than 100 kcal/100 ml after dilution because of the increase in osmolality which may rise above 400 mOsm/kg. This constitutes a major problem because undernourished subjects do not tolerate foods having an osmolality greater than that of blood plasma (290 mOsm/kg approximately) which risk causing diarrhea in them.

Finally, these various powdered products are voluminous during storage and cause numerous problems of transportation and handling.

Sweetened condensed milks have the property of having a very low water content, and consequently these milks resist bacterial contamination. These milks cannot, however, be used in children without prior dilution because of their extremely high osmolality. There is a risk of bacterial contamination and proliferation during this dilution if it is made with contaminated water, which makes their use unsafe when the hygiene conditions are precarious. Even after dilution, these milks retain a very high osmolality, much higher than the limit of 290 mOsm/kg usually observed for infants' diets. Moreover they have a protein lipid and carbohydrate ratio which is very different from that of conventional preparations for normal infants and also very different from the formulas of the F100 or F75 type used in cases of malnutrition. These products are therefore not currently recommended for infants' diets and in particular in undernourished young children.

In order to overcome the disadvantages of complete foods provided in powdered form or based on the principle of concentrated milk, the inventors have described, in Patent Application FR 9714655, a type of food intended for undernourished subjects provided in paste form and prepared by replacing, in the WHO F100 formula, part of the skimmed milk with a mixture of powdered whey and oleaginous, preferably peanut, paste.

These products were an advance in relation to the usual powdered products. Indeed, designed to be consumed as such, without addition of water, these products eliminate the risk of bacterial proliferation which may occur in the case of a reconstitution with contaminated water. Moreover, prepared by coating the ingredients having an osmotic power inside a water-insoluble fat, these products did not develop osmotic activity, thus facilitating their use in children and in undernourished subjects. This type of product nevertheless still had a few drawbacks. First of all, the inclusion of oleaginous paste in the preparation has the drawback of giving a food having a high concentration of phytates which have the property of inhibiting the absorption of certain minerals, in particular zinc, iron and calcium. Phytates are a storage form of the phosphorus present in high concentration in foods of plant origin, and in particular in cereals and leguminous plants, and having the property of binding in solution to divalent cations, making them insoluble and difficult to absorb by the digestive tube. This effect on the absorption of zinc in particular is a major drawback, given that it is a trace element which it is very important to supply in an easily absorbable form in children, more particularly in the event of malnutrition. Moreover, all oleaginous seeds, and in particular peanut, but also soybean, have the property of being able to trigger allergic reactions in sensitized subjects. These reactions are of an exceptional nature, but may be more frequent in certain regions where these foods are not traditionally consumed. Moreover, the inclusion of oleaginous seeds rich in unrefined fat where an onset of oxidation may have occurred can initiate a reaction of oxidation of the other fat entering into the composition of the product, thus limiting the storage life. Finally, the inclusion of oleaginous seeds in order to give a pasty consistency to this food requires the introduction, into the composition of the food, of indigestible carbohydrates which can, in some sensitive subjects, cause flatulence.

A real need therefore exists for nice-tasting complete foods and nutritional supplements, designed to be consumed directly without prior dilution in water, prepared from dairy products, easy to enrich with vitamins and minerals, having a high energy value, containing, as fat, only refined fat, capable of containing products which are sensitive to oxidation such as vitamins, which have a low osmotic pressure so as to avoid side effects such as diarrhea in undernourished subjects.

The inventors have found, surprisingly and unexpectedly, that all these properties were combined when the vegetable fat coating a mixture of powdered dairy products, optionally digestible carbohydrates and a vitamin and mineral supplement, the whole constituting the complete food or the nutritional supplement, was a refined fat containing neither the protein part, nor the indigestible carbohydrate part, nor the mineral part of oleaginous seeds, and had a viscosity at 37° C. of between 50 and 200 centipoises, preferably between 80 and 180 centipoises, still more preferably between 100 and 140 centipoises and contained an emulsifier, for example soybean lecithin.

The subject of the present invention is therefore a complete food or a nutritional supplement rich in lipids, containing not more than 10%, preferably not more than 5% and still more preferably not more than 2% water with respect to its weight, having a low osmolality and stable to oxidation, comprising a mixture of food-grade products in powdered, granular or particulate form, consisting of at least one dairy product, optionally at least one product providing digestible carbohydrates and a vitamin and mineral salt supplement, said mixture being coated with at least one substance rich in refined vegetable fat which contains neither the protein part, nor the indigestible carbohydrate part, nor the mineral part of oleaginous seeds, and which contains an emulsifier and optionally an antioxidant.

In the present invention, the expression “low osmolality” is understood to mean an osmolality of less than 100 mOsm/kg after immersion in a volume of water four times greater than the volume of the food whose osmolality is being measured.

In the text which follows, the term “fat” denotes a refined fat of plant origin which contains neither the protein part, nor the indigestible carbohydrate part, nor the mineral part of oleaginous seeds.

In the present invention, the fat coats the powdered, granular or particulate products entering into the composition of the mixture, whereas in current dietetic products based on dairy products, the fat is on the contrary coated with carbohydrates or proteins, making possible its suspension in water.

The foods prepared according to the present invention are strongly distinguishable by virtue of their physicochemical properties from milk foods intended to be dispersed in water because of this phase inversion: the food described in the present invention is a water-soluble powder in fat mixture, unlike products which are easy to disperse in water which represent a mixture of fat coated with a water-soluble substance.

The coating of the water-soluble ingredients with a lipid layer has the property of making the product described by the invention insoluble in water and of eliminating the osmotic power of the water-soluble ingredients. The approach used for the foods described in the present invention in order to eliminate the osmotic effect of the water-soluble ingredients is very different from that used in the customary dietetic products, involving only ingredients with low osmotic power, such as milk proteins of which the small-sized molecules have been removed by ultrafiltration.

In the present invention, the use of fat of plant origin will be preferred because of their better digestibility compared with fats of animal origin. This fat will be a refined fat enriched with emulsifier, preferably lecithin, and still more preferably soybean lecithin, in an amount preferably between 2% and 5% of the fat, and optionally comprising a food grade antioxidant, preferably tocopherol.

The fat used may be a mixture of various types of vegetable fat. The choice thereof will depend on the desired viscosity at 37° C., between 50 and 200 centipoises, preferably between 80 and 180 centipoises, still more preferably between 100 and 140 centipoises.

The composition of fatty acids which are precursors of essential fatty acids (n-3 and n-6 series) will be adjusted according to the recommendations made for infant foods and for renutrition foods according to the use envisaged.

The ingredients which provide proteins in this invention are exclusively dairy products, which have the advantage of not being associated with phytates capable of inhibiting the absorption of certain trace elements.

The dairy products are chosen from the group comprising in particular skimmed milk, powdered yoghurt, casein, whey, and mixtures thereof.

The complete food or nutritional supplement may comprise a product providing digestible carbohydrates, chosen from the group comprising in particular maltodextrins, sucrose, glucose, fructose, skimmed milk, whey, and mixtures thereof.

The complete food or nutritional supplement according to the invention is artificially enriched with vitamins, and water-soluble or water-insoluble mineral salts or mixtures thereof, by addition of a vitamin and mineral salt “supplement”. Vitamins are substances which are sometimes unstable and minerals sometimes have oxidizing properties. These vitamins and these minerals may be coated with an inert substance, for example with high-melting point fat or alginates of food grade protecting them from oxidation in the case of vitamins and certain minerals or reducing or eliminating their prooxidative properties in the case of certain mineral salts such as copper sulfate for example.

As mineral salts, there may be used without distinction water-soluble or water-insoluble mineral salts, the insoluble mineral salts do not risk sedimenting in this nonaqueous viscous food. The insoluble mineral salts have the advantage of being less expensive and tasteless. By way of example of mineral salts authorized in infants diets by the Codex Alimentarius and frequently added to dietetic products, there may be mentioned zinc sulfate, zinc oxide, copper sulfate, potassium chloride, magnesium oxide and iron fumarate.

According to an advantageous embodiment, the complete food or nutritional supplement may contain, in addition, food additives chosen from the group comprising in particular flavorings and colorings. These additives make it possible to confer on the complete food or nutritional supplement a more appetizing character, thus facilitating its consumption.

According to a most advantageous embodiment of the invention, the ingredients which are provided in powdered form or in particulate or granular form are coated with vegetable fat containing from 2 to 5% emulsifier. This emulsifier is preferably soybean lecithin or any other emulsifier having similar physicochemical properties, and in particular antioxidant properties in addition to its emulsifying properties.

According to a particular embodiment of the invention, the complete food or nutritional supplement in accordance with the invention comprises a mixture:

of 5 to 60%, preferably 20 to 50%, and still more preferably 35 to 40% of vegetable fat containing an emulsifier, preferably soybean lecithin;

of 5 to 60%, preferably 20 to 50%, and still more preferably 35 to 40% skimmed milk;

of 0 to 60%, preferably 2 to 30%, and still more preferably 5 to 10% whey;

of 2 to 55%, preferably 5 to 35%, and still more preferably 10 to 15% of substances rich in carbohydrates which are easily digestible, for example maltodextrins,

of 1 to 15%, preferably 2 to 10%, still more preferably 3 to 5% sucrose,

said percentages being expressed by weight relative to the total weight of the complete food or nutritional supplement.

The various percentages are adjusted according to the type of diet to be followed, in particular if it is a food intended for well fed infants or renutrition foods to be used at the beginning of a treatment or during the phase of rapid growth.

The final product, complete food or nutritional supplement according to the invention, is provided in the form of a viscous or semiviscous paste. The final product is sparingly soluble in water. It is a mixture consisting of a powdered, granular or particulate phase, which is anhydrous or which contains a very low content of water contained in a pasty lipid phase containing an emulsifier, preferably soybean lecithin, promoting the mixing of the ingredients and having antioxidant properties. This mixture being very sparingly soluble in water, it does not therefore develop a notable osmotic pressure. The osmolality remains below 200 mOsm/kg, preferably below 100 mOsm/kg when the product is immersed in a quantity of water four times its own weight. This property persists as long as the product has not been suspended by vigorous stirring.

The consistency of the final product may be chosen according to its use by modifying the quantity of fat introduced into the mixture and by varying the fatty acid composition of the fat used. The viscosity at 37° C. of this complete food or nutritional supplement allows the product to be consumed by infants, generally from the age of one year. It can also be easily swallowed by undernourished patients having a highly diminished muscle force.

Preferably, the viscosity of the complete food or nutritional supplement according to the invention is sufficiently low to be able to flow if it is contained in a flexible packaging on which slight pressure is exerted, while being sufficiently high so as not to spread spontaneously under the effects of its own weight.

The complete food or nutritional supplement, because of its variable viscosity, can be molded in an impervious packaging so as to reduce to the maximum the quantities of residual air present in the packaging. In this case, the surface of contact between the lipid component of this product and the ambient atmosphere is greatly reduced compared with equivalent powdered products.

Moreover, by virtue of its composition, the complete food or nutritional supplement allows preservation of the fragile substances which it contains under optimum conditions given that they are coated with a substance rich in lipids, said substance forming a barrier to oxygen, to moisture and between the various constituents capable of reacting with each other. The protective properties of the vegetable fat used are reinforced by incorporating an emulsifier such as soybean lecithin having antioxidant properties in an amount preferably of between 2% and 5% fat and optionally with an antioxidant such as tocopherol.

The lack of air inside this food or this nutritional supplement increases the density thereof. It can be accepted that 1 tonne of this complete food or nutritional supplement occupies a volume of approximately 1 m³, whereas an equivalent powdered product would occupy a volume of 2 m³. This high density greatly facilitates the transportation of this complete food or of these nutritional supplements compared with equivalent powdered products.

The foods according to the invention have an energy density greater than 400 kcal/100 g, preferably greater than 500 kcal/100 g.

Thus, the complete food or nutritional supplement has an energy value which is much greater than that of products conventionally used in the renutrition diets obtained after diluting a powdered product in water, the dissolution of which powdered products in an aqueous medium requires a limit in terms of energy content because of the problems of hyperosmolality. The conventional powdered products have an osmolality exceeding the limit of 290 mOsm/kg after dilution in an aqueous medium as soon as the energy density is greater than 100 kcal/100 ml.

The complete food or nutritional supplement according to the invention may be prepared by a method according to which there are added to the fat supplemented with emulsifier, preferably soybean lecithin, and optionally antioxidants, all the powdered products or products in particulate or granular form, and then the mixture is blended in a mixer in a first instance and then in a grinder and the resulting composition is poured into the packaging.

According to an advantageous embodiment, the method for manufacturing the complete food or nutritional supplement in accordance with the invention comprises the following steps:

melting, at a temperature of between 40° C. and 60° C., a pasty vegetable fat supplemented with an emulsifying substance, preferably soybean lecithin, in an amount preferably of between 2% and 5% fat, and optionally supplemented with antioxidant;

adding, with stirring, to the molten vegetable fat the mixture of vitamins and mineral salts;

then incorporating each of the ingredients providing the proteins and the carbohydrates, provided in the form of a fine powder or in particulate or granular form;

blending until a homogeneous paste is obtained;

grinding in a high-speed grinder;

and then pouring the paste thus obtained into packagings.

In the present invention, contact between the various constituents and the emulsifier used, preferably soybean lecithin, is facilitated by passing through a grinder with a high rotating speed after initial mixing.

Preferably, in order to facilitate compliance with the dietary regime, packagings are used which contain the quantity of complete food or nutritional supplement consumed during one meal or a quantity sufficient to meet the daily nutritional needs of the person to whom this product has to be administered.

The foods in accordance with the invention are sparingly soluble in water and do not generate a notable osmolality before dispersion by stirring. They are stable and resistant to oxidation.

The complete food or nutritional supplement is intended to be consumed directly in paste form, without prior dilution in water. It may be used in nutritional programs intended in particular for young children, as a general rule after the age of one year, for elderly persons and for adolescents.

Given the absence of dilution in water, the problems of bacterial proliferation, in particular following bacterial contamination with water or the containers in which the dilutions are made, are avoided.

After adjusting their formula, these complete foods can serve to cover the nutritional requirements of infants, defined as being over 12 months and less than 36 months, as long as they are capable of swallowing a food provided in paste form and are capable of spontaneously consuming the quantities of water which they require independently of their food.

After adjusting their formula to take into account specific nutritional requirements which appear in the case of undernourishment, the foods covered by the invention can also serve as complete foods for feeding severely undernourished patients.

The present invention will be illustrated with the aid of the following examples which are not limiting.

### EXAMPLES

### Example 1

Food Provided in the Form of a Paste Having a Nutritional Composition Corresponding to that of Follow-on Preparations for Infants (CODEX STAN 156-1987 Standard, Amended in 1989)

A mixture is prepared in a mixer, containing:

40 kg of skimmed milk powder,

12.85 kg of maltodextrins,

10 kg of sugar,

5 kg of magnesium caseinate,

32 kg of vegetable fat containing 4% lecithin,

0.15 kg of mineral or vitamin supplement whose composition is given in Table 1.

The direction of rotation of the mixer is reversed every time a new ingredient is introduced (5 revolutions/minute until half of the ingredients have been poured in, then 30 revolutions/minute, and then with a rotation prolonged for at least 10 minutes after completion of the pouring in of the last ingredient). When all the ingredients have been incorporated, the walls of the mixer are scraped with a blade and the rotation is continued until the mixture has been poured into a grinder (minimum 10 minutes of mixing).

The refined vegetable fat used in this example has the lipid profile given in Table 2. It is supplemented with 4% soybean lecithin (expressed in terms of the weight of the fat) and also with 750 mg per kg of tocopherol.

This product has a nutritional composition corresponding to the nutritional standards of follow-on preparations for infants, in particular as regards its content of lipids and proteins (Table 3) and of vitamins and minerals.

Its use may be envisaged for unweaned babies preferably more than six months old, still more preferably for young children more than one year old for whom the liquid part of a weaning diet may be replaced with a pasty food. This food has the advantage in that it can be used to feed children who are not breast fed and who have acquired deglutition reflexes allowing them to swallow food in paste form and to replace the equivalent liquid products.

TABLE 1
Mixture of vitamins and minerals used in
Example 1

| | Quantity |
|---|---|
| Products | (per 100 g of food) |
| Vitamin A | 450 μg |
| Vitamin D | 6 μg |
| Vitamin E | 20 mg |
| Vitamin C | 50 mg |
| Vitamin B1 | 250 μg |
| Vitamin B2 | 360 μg |
| Vitamin B6 | 280 μg |
| Vitamin B12 | 1 μg |
| Vitamin B9 | 25 μg |
| Vitamin PP | 1.5 mg |
| Pantothenic acid | 1.8 mg |
| Biotin | 10 μg |
| Vitamin K1 | 25 μg |
| Iron sulfate (monohydrate) | 24 mg |
| Zinc sulfate (monohydrate) | 4 mg |
| Potassium iodate | 50 μg |

TABLE 2
Composition of the fat used in Example 1

| Fatty acid | Percentage | Fatty acid | Percentage |
|---|---|---|---|
| C6 | 0.10 | C18:1 | 35.70 |
| C8 | 1.40 | C18:2 | 13.85 |
| C10 | 1.20 | C18:3 | 5.70 |
| C12 | 16.00 | C20:0 | 0.45 |
| C14 | 5.50 | C20:1 | 0.8 |
| C16 | 8.90 | C22:0 | 0.20 |
| C17:0 | 0.05 | C22:1 | 0.20 |
| C18:0 | 9.25 | C24:0 | 0.10 |
| | | various | 0.45 |

TABLE 3
Nutritional composition given as a guide for the
complete food described in Example 1

| | Quantity per 100 g | g per 100 kcal |
|---|---|---|
| Energy | 540 kcal | — |
| Proteins | 18.5 g | 3.42 |
| Carbohydrates | 43 g | |
| Lipids | 32 g | 5.9 |

### Example 2

Nutritional Supplement Provided in the Form of a Fatty Paste Containing Only Milk Proteins as Protein Source

A mixture is prepared which contains:

40 kg of vegetable fat,

37 kg of skimmed milk powder,

9.9 kg of whey,

13 kg of sucrose,

0.10 kg of mineral and vitamin supplement whose composition is given in Table 4.

The manufacturing technique is the same as for Example 1. The fat used in the preparation of this food is the same as that of the preceding example. It is likewise enriched with soybean lecithin and tocopherol. This product may be used as such, as a supplement for a compound diet essentially based on cereals.

It may also be mixed with a gruel, but in this case, it loses the properties of resistance to bacterial contamination which characterizes this product when used alone.

TABLE 4
Mixture of vitamins and minerals used in Example 2

| | Quantity |
|---|---|
| Products | (per 100 g of food) |
| Vitamin A | 0.55 mg |
| Vitamin D | 7 μg |
| Vitamin C | 33 mg |
| Vitamin B1 | 0.7 mg |
| Vitamin B2 | 0.80 mg |
| Vitamin B6 | 1 mg |
| Vitamin B12 | 1 μg |
| Vitamin B9 | 140 μg |
| Vitamin PP | 6 mg |
| Iron sulfate | 25 mg |
| Zinc sulfate | 10 mg |
| Copper sulfate | 2 mg |
| Potassium iodate | 150 μg |

### Example 3

Complete Food which Makes it Possible to Re-feed an Undernourished Subject

The quantities are expressed as a percentage of the total mixture prepared in the kneader.

36% of vegetable fat as defined in Example 1, also enriched with soybean lecithin and tocopherol, is poured into a kneader. 1% of the complex of vitamins and mineral salts which is described in Table 5 is incorporated by dispersing it in the whole mixture. The following are then successively introduced into the kneader while mixing:

39% of skimmed milk powder,

9% of whey,

10.50% of maltodextrins,

4% of sugar,

0.5% of caramel flavor.

The manufacturing technique is the same as for Example 1.

The nutritional composition of this complete food corresponds to that of the WHO F100 before dilution with water. This formula has an energy value of 545 kcal/100 g, which is more than five times that of the formula F100 after dilution. It is consumed as such, without prior dilution in water.

TABLE 5
Mixture of vitamins and minerals used in Example 3

| | Quantity |
|---|---|
| Products | (per 100 g of food) |
| Vitamin A | 0.91 mg |
| Vitamin D | 16 μg |
| Vitamin E | 20 mg |
| Vitamin C | 53 mg |
| Vitamin B1 | 0.60 mg |
| Vitamin B2 | 1.80 mg |
| Vitamin B6 | 0.7 mg |
| Vitamin B12 | 1.80 μg |
| Vitamin B9 | 210 μg |
| Vitamin PP | 6 mg |
| Pantothenic acid | 3.1 mg |
| Biotin | 65 μg |
| Vitamin K | 21 μg |
| Iron sulfate | 34 mg |
| Zinc sulfate | 33 mg |
| Magnesium citrate | 3651 mg |
| Copper sulfate | 6.84 mg |
| Potassium chloride | 320 mg |
| Sodium selenite | 57 μg |
| Potassium iodate | 186 μg |

1. A complete food or nutritional supplement designed to be consumed as such, without addition of water, rich in lipids, containing not more than 10%, preferably not more than 5% and still more preferably not more than 2% water with respect to its own weight, having an osmolality of less than 100 mOsm/kg after immersion in a volume of water four times greater than its own, comprising a mixture of food grade products in powdered, granular or particulate form, consisting of at least one powdered dairy product, optionally at least one product providing digestible carbohydrates and a vitamin and mineral salt supplement, said mixture being coated with at least one substance rich in vegetable fat containing an emulsifier and optionally an antioxidant but containing neither the protein part, nor the indigestible carbohydrate part, nor the mineral part of oleaginous seeds.

2. The complete food or nutritional supplement as claimed in claim 1, characterized in that the mixture of food grade powdered products, coated with a refined fat containing an emulsifier, contains:
at least one powdered dairy product providing proteins chosen from the group comprising in particular skimmed milk, powdered yoghurt, casein, whey, and mixtures thereof;
optionally at least one product providing carbohydrates chosen from the group comprising in particular sucrose, glucose, fructose, maltodextrin, skimmed milk, whey, and mixtures thereof;
a mixture of food grade vitamins and mineral salts optionally coated with an inert substance (wax or alginate for example) protecting it from oxidation; and
optionally food grade additives chosen from the group comprising in particular flavorings and colorings.

3. The complete food or nutritional supplement as claimed in claim 1 or claim 2, characterized in that the refined vegetable fat used for the preparation contains an emulsifier, preferably soybean lecithin, in an amount preferably between 2% and 5%, said vegetable fat having a viscosity at 37° C. between 50 and 200 centipoises, preferably between 80 and 180 centipoises, still more preferably between 100 and 140 centipoises.

4. The complete food or nutritional supplement as claimed in any one of claims 1 to 3, characterized in that it comprises a mixture:
of 5 to 60%, preferably 20 to 50%, and still more preferably 35 to 40% skimmed milk;
of 0 to 60%, preferably 2 to 30%, and still more preferably 5 to 10% whey;
of 2 to 55%, preferably 5 to 35%, and still more preferably 10 to 15% high molecular weight carbohydrate substance;
of 1 to 15%, preferably 2 to 10%, and still more preferably 3 to 5% sucrose,
said percentages being expressed by weight relative to the total weight of said complete food or nutritional supplement,
said mixture being coated with 5 to 60%, preferably 20 to 50% and still more preferably 35 to 40% of vegetable fat containing neither the protein part, nor the indigestible carbohydrate part, nor the mineral part of oleaginous seeds, said fat being enriched to a level, expressed relative to the fat, of 2 to 5% emulsifier, preferably soybean lecithin.

5. The complete food or nutritional supplement as claimed in any one of claims 1 to 4, provided in the form of a viscous or semiviscous paste sparingly soluble in water, developing an osmolality of less than 100 mOsm/kg and preferably less than 50 mOsm/kg after immersion in a volume of water four times greater than its own as long as the product has not been dispersed by stirring.

6. The complete food or nutritional supplement as claimed in any one of claims 1 to 5, having an energy value greater than 400 kcal, preferably greater than 500 kcal per 100 g.

7. A method for preparing a complete food or food supplement as claimed in any one of claims 1 to 6, characterized in that there are added to the pasty vegetable fat, enriched beforehand with emulsifier and optionally with antioxidant, dairy products providing proteins, optionally products providing carbohydrates, vitamins, mineral salts, optionally additives, and then the product thus obtained is poured into the packaging.

8. A method for manufacturing the complete food or nutritional supplement as claimed in one of claims 1 to 7, comprising the steps consisting in:
melting, at a temperature of between 40° C. and 60° C., a pasty vegetable fat supplemented with an emulsifying substance, preferably soybean lecithin, in an amount preferably of between 2% and 5% (expressed in terms of the amount of fats), and optionally supplemented with an antioxidant;
adding, with stirring, to the molten vegetable fat the mixture of vitamins and mineral salts;
then incorporating each of the ingredients provided in the form of a fine powder or in particulate or granular form;
blending until a homogeneous paste is obtained;
and then pouring the paste thus obtained into packagings.

9. The method as claimed in claim 7 or 8, characterized in that the mixture of these different constituents is homogenized by passing through a grinder with a high rotating speed.

10. The use of the complete food or nutritional supplement according to any one of claims 1 to 6 or prepared according to any one of claims 7 to 9, in nutritional programs of renutrition or of nutritional supplementation or for compensating for vitamin or mineral salt deficiencies.

11. The use as claimed in claim 10, directly, without prior dilution in water or alternatively in dilute form, as a supplement for a diet based on cereals.
